(19) United States
(12) Patent Application Publication
(10) Pub. No.: US 2016/0161994 A1
(43) Pub. Date: Jun. 9, 2016

(54) FIBER HINGE

(71) Applicant: HEWLETT-PACKARD DEVELOPMENT COMPANY, L.P., Houston, TX (US)

(72) Inventor: CHIEN-KUO LEE, TAIPEI (TW)

(73) Assignee: HEWLETT-PACKARD DEVELOPMENT COMPANY L.P., HOUSTON, TX (US)

(21) Appl. No.: 14/892,028

(22) PCT Filed: Jul. 19, 2013
(86) PCT No.: PCT/US2013/051285

§ 371 Date: Nov. 18, 2015

(51) Int. Cl. G06F 1/16; F16C 11/04; B23P 15/00; E05D 3/02

(52) U.S. Cl. CPC G06F 1/1681; E05D 3/02; F16C 11/04; B23P 15/00; E05Y 2900/606; B23P 2700/11

(57) ABSTRACT

A method, a hinge apparatus, and a hinge system including a first fiber tube formed from a multi-layer fiber substrate having a first set of fibers and a second set of fibers arranged therein.

### BACKGROUND

Hinge apparatuses may connect a plurality of members to move them with respect to each other. Such hinge apparatuses may be used in computer systems such as laptops, for example, to move a display member with respect to a main body to selectively place the computer system in a dosed state and an open state.

### BRIEF DESCRIPTION OF THE DRAWINGS

Non-limiting examples are described in the following description, read with reference to the figures attached hereto and do not limit the scope of the claims. Dimensions of components and features illustrated in the figures are chosen primarily for convenience and clarity of presentation and are not necessarily to scale. Referring to the attached figures:

FIG. 1 is a block diagram illustrating a hinge apparatus according to an example.

FIG. 2 is a schematic view illustrating a hinge apparatus usable with a computer system according to an example.

FIG. 3 is a block diagram illustrating a hinge system according to an example.

FIG. 4 is a schematic view illustrating hinge system usable with a computer system according to an example.

FIGS. 5A-5B are side views illustrating respective assembly brackets of the hinge system of FIG. 3 according to examples.

FIG. 6 is a flowchart illustrating a method of forming a hinge apparatus according to an example.

FIGS. 7A-7F are schematic views illustrating formation of the hinge apparatus of FIG. 2 according to an example.

### DETAILED DESCRIPTION

Hinge apparatuses may connect a plurality of members to move them with respect to each other. The hinge apparatuses may be used in computer systems such as laptops, for example, to move a display member with respect to a main body to selectively place the computer system in a closed state and an open state. Thus, the hinge apparatuses may be robust to support the display member and/or the main body. The hinge apparatuses may be made entirely of metal. The hinge apparatuses may also include longitudinal openings for electrical wires to pass through and/or reside therein. Consequently, such hinge apparatuses may have an increased size and/or weight.

In examples, a method of forming a hinge apparatus may include combining a plurality of fiber layers to form a multi-layer fiber substrate, rolling the multi-layer fiber substrate into a first fiber tube, and placing a portion of one of the first fiber tube and a second tube into the other of the first fiber tube and the second tube. The method may also include placing a first end of a first assembly bracket onto the first fiber tube and placing a first end of a second assembly bracket onto the second tube. Thus, the hinge apparatus including a multi-layer fiber tube may be robust and include an ability to pass an electrical wire there through without increasing a weight and/or a size thereof.

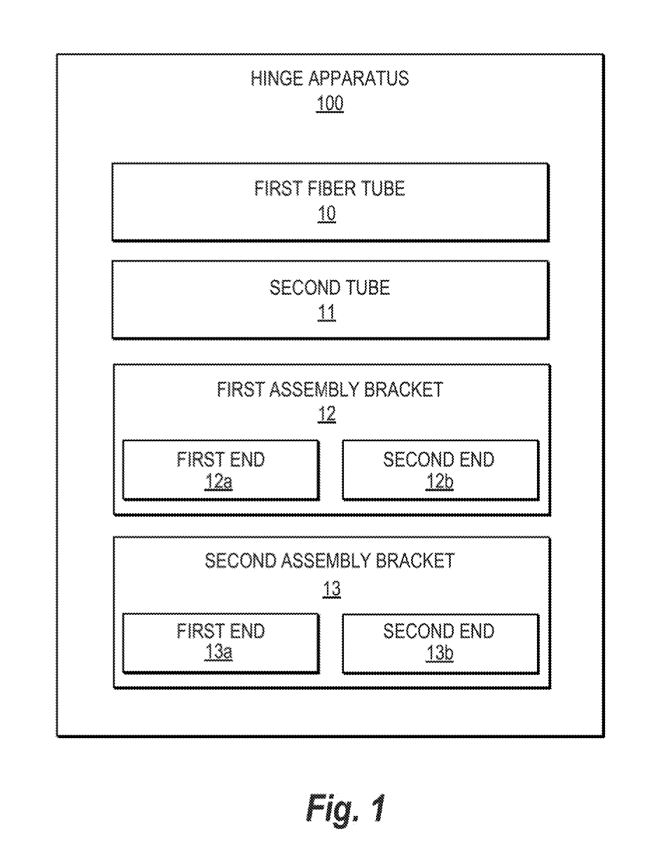

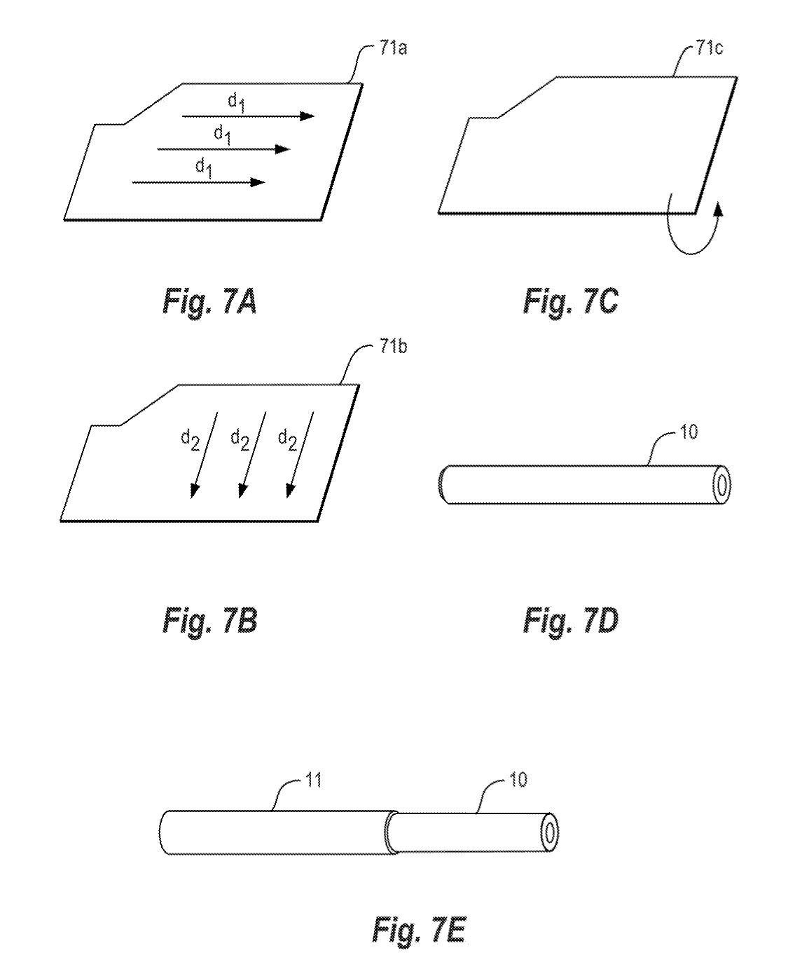

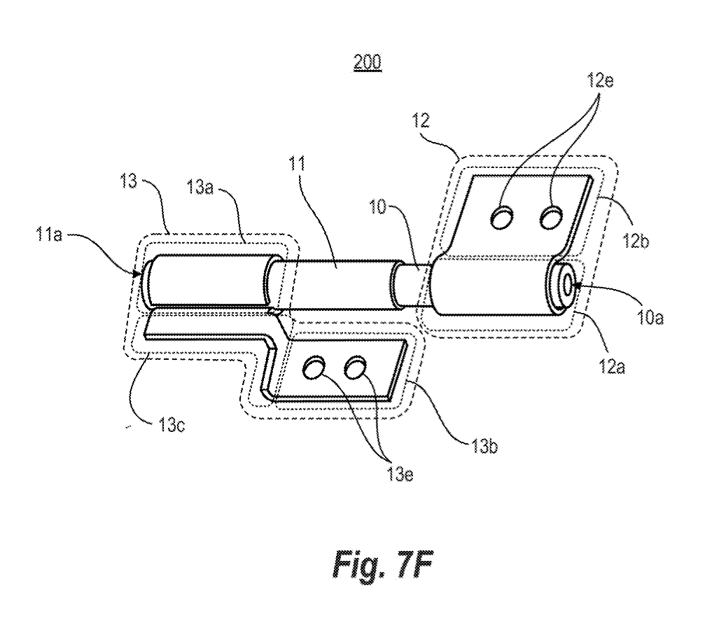

FIG. 1 is a block diagram illustrating a hinge apparatus according to an example. Referring to FIG. 1, in some examples, a hinge apparatus 100 may include a first fiber tube 10, a second tube 11, a first assembly bracket 12, and a second assembly bracket 13. The first fiber tube 10 may be formed from a multi-layer fiber 71c substrate (FIG. 7C) having a first set of fibers and a second set of fibers arranged therein. For example, the multi-layer fiber substrate 71c may be formed from a first fiber layer 71a and a second fiber layer 71b as illustrated in FIGS. 7A-7C. In some examples, the first set of fibers and the second set of fibers may include at least one of glass fibers and carbon fibers.

Referring to FIG. 1, in some examples, the second tube 11 may be movably coupled to the first fiber tube 10. In some examples, the second tube 11 may be formed from metal. The second tube 11 and the first fiber tube 10 may be configured to rotate with respect to each other. Torque may be created by friction caused between the first fiber tube 10 and the second tube 11. In some examples, the first assembly bracket 12 may include a first end 12a and a second end 12b. The first end 12a of the first assembly bracket 12 may be coupled to the first fiber tube 10.

In some examples, the first end 12a of the first assembly bracket 12 may be stationary with respect to the first fiber tube 10 to allow the first assembly bracket 12 to move in synchronization with the first fiber tube 10. The second assembly bracket 13 may include a first end 13a and a second end 13b. The first end 13a of the second assembly bracket 13 may be coupled to the second tube 11. In some examples, the first end 13a of the second assembly bracket 13 may be stationary with respect to the first fiber tube 10 to allow the second assembly bracket 13 to move in synchronization with the first fiber tube 10. In some examples, the first and second assembly brackets 12 and 13 may be formed of metal.

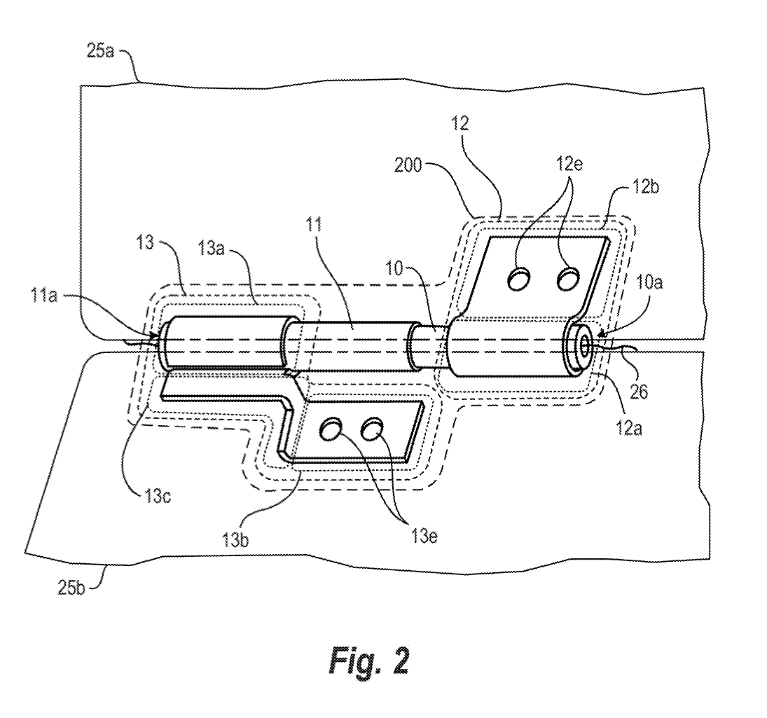

FIG. 2 is a schematic view illustrating a hinge apparatus usable with a computer system according to an example. Referring to FIG. 2, in some examples, a hinge apparatus 200 may include the first fiber tube 10, a second tube 11, a first assembly bracket 12, and a second assembly bracket 13 as previously discussed with respect to the hinge apparatus 100 of FIG. 1. Referring to FIG. 2, in some examples, the second end 12b of the first assembly bracket 12 may attach to a first member 25a of a computer system such as a display member. For example, the second end 12b of the first assembly bracket 12 may include holes 12e to receive fasteners to attach the first assembly bracket 12 to the first member 25a.

Additionally, the second end 13b of the second assembly bracket 13 may be attached to a second member 25b of the computer system such as a main body. For example, the second end 13b of the second assembly bracket 13 may include holes 13e to receive fasteners to attach the second assembly bracket 13 to the second member 25b. That is, the hinge apparatus 200 may rotate the first member 25a with respect to the second member 25b. in some examples, a computer system such as a laptop may include a set of hinge apparatuses 200 to rotate the first member 25a with respect to the second member 25b.

Referring to FIG. 2, in some examples, the second assembly bracket 13 may include an offset portion 13c disposed between the first end 13a and the second end 13b of the second assembly bracket 13. The offset portion 13c may offset the first end 13a from the second end 13b of the second assembly bracket 13. For example, the offset portion 13c may be angular-shaped. In some examples, the first fiber tube 10 may include a first longitudinal opening 10a. The second tube 11 may include a second longitudinal opening 11a. The first and second longitudinal openings 10a and 11a may receive an electrical wire to provide power and/or communication to various components within the first member 25a and/or second member 25b of the computer system.

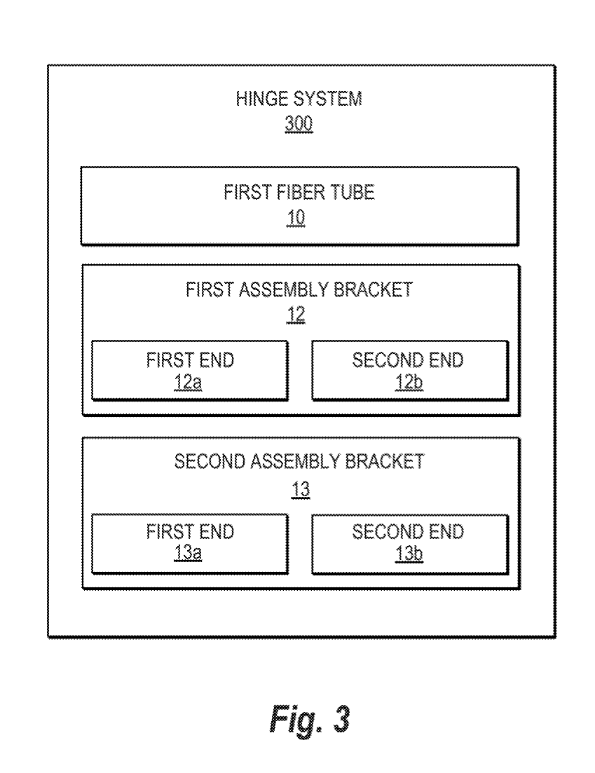

FIG. 3 is a block diagram illustrating a hinge system according to an example. Referring to FIG. 3, in some examples, a hinge system 300 may include a first fiber tube 10, a first assembly bracket 12, and a second assembly bracket 13. The first fiber tube 10 may be formed from a multi-layer fiber substrate 710 (FIG. 7C) having a first set of fibers and a second set of fibers arranged therein. For example, the multi-layer fiber substrate 71c may be formed from a first fiber layer 71a and a second fiber layer 71b as illustrated in FIGS. 7A-7C. In some examples, the first set of fibers and the second set of fibers include at least one of glass fibers and carbon fibers.

Referring to FIG. 3, in some examples, the first assembly bracket 12 may include a first end 12a and a second end 12b. The first end 12a of the first assembly bracket 12 may be movably coupled to the first fiber tube 10. That is, the first assembly bracket 12 may rotate with respect to the first fiber tube 10. The second assembly bracket 13 may include a first end 13a and a second end 13b. The first end 13a of the second assembly bracket 13 may be movably coupled to the first fiber tube 10. That is, the second assembly bracket 13 may rotate with respect to the first fiber tube 10.

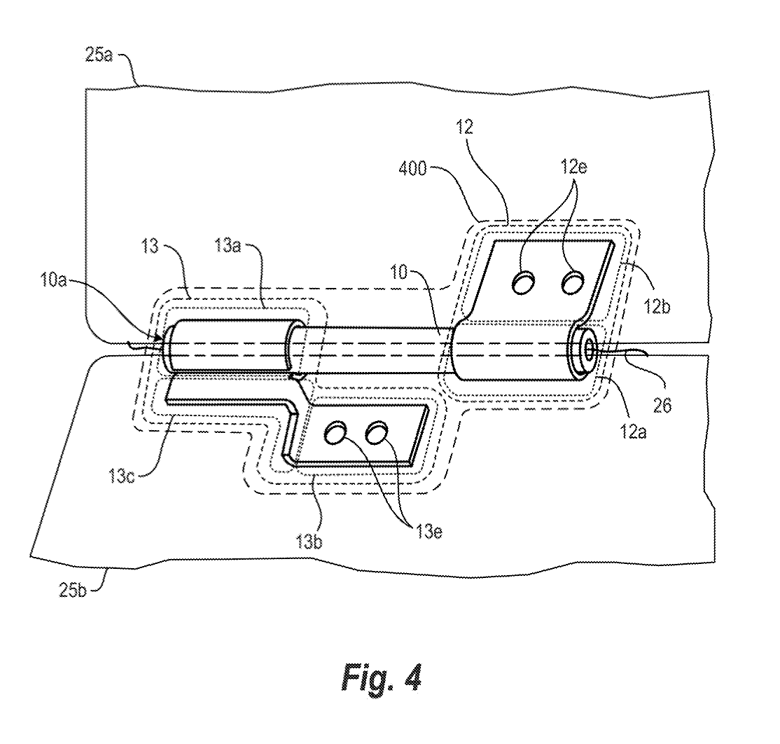

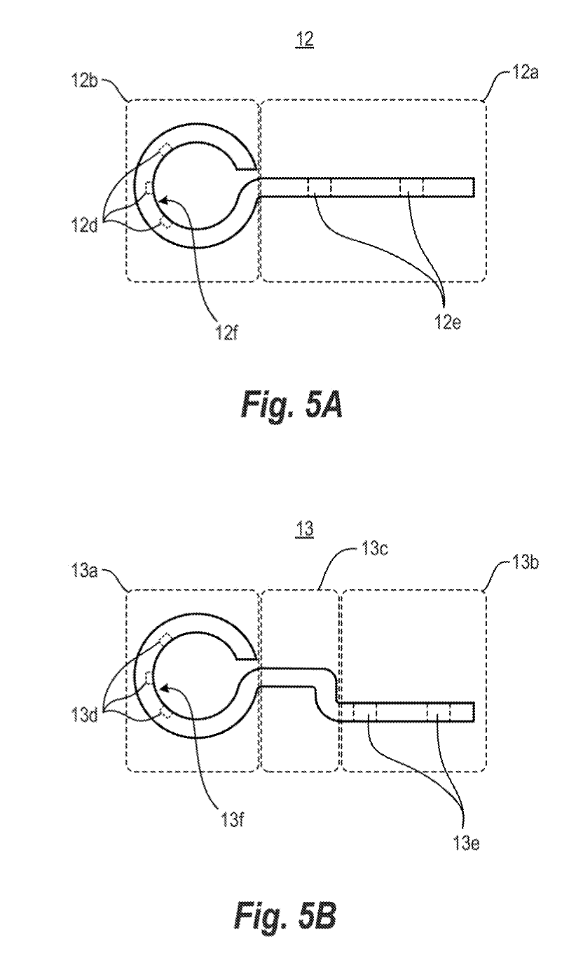

FIG. 4 is a schematic view illustrating a hinge system usable with a computer system according to an example. FIGS. 5A and 5B are side views illustrating respective assembly brackets of the hinge system of FIG. 3 according to examples. Referring to FIGS. 4-5B, in some examples, a hinge system 400 may include the a first fiber tube 10, a first assembly bracket 12, and a second assembly bracket 13 as previously discussed with respect to the hinge system 300 of FIG. 3. Referring to FIGS. 4-5B, in some examples, the respective first ends 12a and 13a of the first assembly bracket 12 and the second assembly bracket 13 may be curved, for example, to surround the first fiber tube 10. Additionally, the respective second ends 12b and 13b of the first assembly bracket 12 and the second assembly bracket 13 may be substantially flat.

Referring to FIGS. 4-5B, in some examples, the respective second ends 12b and 13b of the respective assembly brackets 12 and 13 may include holes 12e and 13e to receive fasteners to attach the respective assembly brackets 12 and 13 to the other members. For example, the second end 12b of the first assembly bracket 12 may attach to a first member 25a of a computer system such as a display member. Additionally, the second end 13b of the second assembly bracket 13 may be attached to a second member 25b of the computer system such as a main body.

Referring to FIGS. 4-5B, in some examples, in some examples, the first end 12a of the first assembly bracket 12 may include a first lubricated surface 52c to contact the first fiber tube 10. Additionally, the first end 13a of the second assembly bracket 13 may include a second lubricated surface 53c to contact the first fiber tube 10. For example, the lubricated surfaces 52c and 53c may include a plurality of concavities 52d and 53d and a lubricant placed therein to assist in smooth movement of the respective assembly brackets 12 and 13 with respect to the first fiber tube 10. In some examples, the lubricant may be white lithium grease, a silicon lubricant, and the like.

Referring to FIGS. 4-5B, in some examples, the second assembly bracket 13 may include an offset portion 13c disposed between the first end 13a and the second end 13b of the second assembly bracket 13. The offset portion 13c may offset the first end 13a from the second end 13b of the second assembly bracket 13. For example, the offset portion 13c may be angular-shaped. The first fiber tube 10 may include a first longitudinal opening 10a to receive an electrical wire 26 therein. In some examples, the respective second ends 12b and 13b of the first and second assembly brackets 12 and 13 may include holes 12e and 13e to receive fasteners to attach the respective assembly brackets 12 and 13 to other members 25a and 25b.

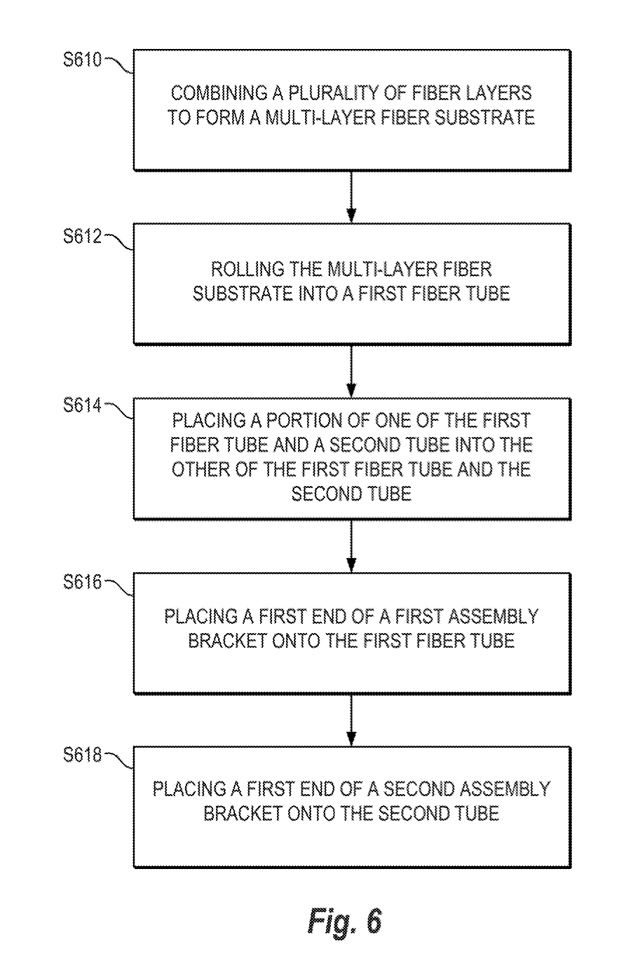

FIG. 6 is a flowchart illustrating a method of forming a hinge apparatus according to an example. FIGS. 7A-7F are schematic views illustrating a formation of the hinge apparatus of FIG. 2 according to an example. In block S610, a plurality of fiber layers are combined to form a multi-layer fiber substrate 71c as illustrated in FIGS. 7A-7C. For example, a first fiber layer 71a having a first set of fibers formed therein arranged in a first direction d₁ may be combined with a second fiber layer 71b having a second set of fibers formed therein arranged in a second direction d₂ different than the first direction d₁. In some examples, the first direction d₁ and the second direction d₂ may be substantially perpendicular to each other. In some examples, the first set of fibers and the second set of fibers may include at least one of glass fibers and carbon fibers. In some examples, a second fiber layer 71b may be placed on a first fiber layer 71a. The second fiber layer 71b may be permanently attached to the first fiber layer 71a to form the multi-layer fiber substrate 71c through application of heat, pressure, and/or adhesives, and the like.

In block S612, the multi-layer fiber substrate 71c is rolled into a first fiber tube 10 as illustrated in FIGS. 7C-7D. In some examples, the multi-layer fiber substrate 71c may be temporarily attached and/or placed against an elongated, cylindrical object. Pressure may be applied to the multi-layer fiber substrate 71c against the cylindrical object as it is rolled to allow the multi-layer fiber substrate 71c to roll onto itself resulting in the rolled, multi-layer fiber substrate 71c having a circular cross-section. Subsequently, the cylindrical object is removed from the rolled, multi-layer fiber substrate 71c resulting in the formation of a hollow, fiber tube 10.

In block S614, a portion of one of the first fiber tube 10 and a second tube 11 is placed into the other of the first fiber tube 10 and the second tube 11 as illustrated in FIG. 7E. In some examples, one of the first fiber tube 10 or the second tube 11 may heated or cooled to enable it to fit into the other of the first fiber tube 10 or second tube 11. In block S616, a first end 12a of a first assembly bracket 12 is placed onto the first fiber tube 10 as illustrated in FIG. 7F. In some examples, the first tube 10 may be inserted into the first end 12a of the first assembly bracket 12. In some examples, one of the first tube 10 or the first end 12a of the first assembly bracket 12 may be heated or cooled to enable it to fit into the other of the first tube 10 or the first end 12a. Alternatively, the first end 12a may be squeezed onto the second tube 11.

In block S618, a first end 13a of a second assembly bracket 13 is placed onto the second tube 11 as illustrated in FIG. 7F. In some examples, the second tube 11 may be inserted into the first end 13a of the second assembly bracket 13. In some examples, one of the second tube 11 or the first end 13a of the second assembly bracket 13 may be heated or cooled to enable it to fit into the other of the second tube 11 or the first end 13a. Alternatively, the first end may be squeezed onto the second tube 11. Additionally, in some examples, the second assembly bracket 13 may include an offset portion 13c disposed between the first end 13a and the second end 13b of the second assembly bracket 13. For example, the offset portion 13c may be angular-shaped and offset the first end 13a from the second end 13b the second assembly bracket 13.

The method may also include rotating the first fiber tube 10 and the second tube 11 with respect to each other to create torque by friction caused between the first fiber tube 10 and the second tube 11. For example, a first member 25a of a computer system attached to a second end 12b of the first assembly bracket 12 may be rotated with respect to a second member 25b of the computer system attached to a second end 13b of the second assembly bracket 13. The method may also include placing an electrical wire through at least one of a first longitudinal opening 10a of the first fiber tube 10 and a second longitudinal opening 11a of the second tube 11.

It is to be understood that the flowchart of FIG. 6 illustrates architecture, functionality, and/or operation of examples of the present disclosure. If embodied in software, each block may represent a module, segment, or portion of code that includes one or more executable instructions to implement the specified logical function(s). If embodied in hardware each block may represent a circuit or a number of interconnected circuits to implement the specified logical function(s). Although the flowchart of FIG. 6 illustrates a specific order of execution, the order of execution may differ from that which is depicted. For example, the order of execution of two or more blocks may be rearranged relative to the order illustrated. Also, two or more blocks illustrated in succession in FIG. 6 may be executed concurrently or with partial concurrence. All such variations are within the scope of the present disclosure.

The present disclosure has been described using non-limiting detailed descriptions of examples thereof that are not intended to limit the scope of the general inventive concept. It should be understood that features and/or operations described with respect to one example may be used with other examples and that not all examples have all of the features and/or operations illustrated in a particular figure or described with respect to one of the examples. Variations of examples described will occur to persons of the art. Furthermore, the terms “comprise,” “include,” “have” and their conjugates, shall mean, when used in the disclosure and/or claims, “including but not necessarily limited to.”

It is noted that some of the above described examples may include structure, acts or details of structures and acts that may not be essential to the general inventive concept and which are described for illustrative purposes. Structure and acts described herein are replaceable by equivalents, which perform the same function, even if the structure or acts are different, as known in the art. Therefore, the scope of the general inventive concept is limited only by the elements and limitations as used in the claims.

What is claimed is:

1. A method of forming a hinge apparatus, the method comprising:
combining a plurality of fiber layers to form a multi-layer fiber substrate;
rolling the multi-layer fiber substrate into a first fiber tube;
placing a portion of one of the first fiber tube and a second tube into the other of the first fiber tube and the second tube;
placing a first end of a first assembly bracket onto first fiber tube; and
placing a first end of a second assembly bracket onto the second tube.

2. The method of claim 1, wherein the combining a plurality of fiber layers to form a multi-layer fiber substrate further comprises:
combining a first fiber layer having a first set of fibers formed therein arranged in a first direction with a second fiber layer having a second set of fibers formed therein arranged in a second direction different than the first direction.

3. The method of claim 1, further comprising:
rotating the first fiber tube and the second tube with respect to each other to create torque by friction caused between the first fiber tube and the second tube.

4. The method of claim 1, further comprising:
placing an electrical wire through at least one of a first longitudinal opening of the first fiber tube and a second longitudinal opening of the second tube.

5. The method of claim 1, further comprising:
rotating a first member of a computer system attached to a second end of the first assembly bracket with respect to a second member of the computer system attached to a second end of the second assembly bracket.

6. The method of claim 1, wherein the first set of fibers and the second set of fibers comprise at least one of glass fibers and carbon fibers.

7. A hinge apparatus, comprising:
a first fiber tube formed from a multi-layer fiber substrate having a first set of fibers and a second set of fibers arranged therein;
a second tube movably coupled to the first fiber tube, the second tube and the first fiber tube are configured to rotate with respect to each other;
a first assembly bracket having a first end and a second end, the first end of the first assembly bracket is coupled to the first fiber tube; and
a second assembly bracket having a first end and a second end, the first end the second assembly bracket is coupled to the second tube.

8. The hinge apparatus of claim 7, wherein the second end of the first assembly bracket is attached to a first member of a computer system and the second end of the second assembly bracket is attached to a second member of the computer system to rotate the first member with respect to the second member.

9. The hinge apparatus of claim 7, wherein the first fiber tube includes a first longitudinal opening and the second tube includes a second longitudinal opening to receive an electrical wire therein.

10. The hinge apparatus of claim 7, wherein the first set of fibers and the second set of fibers comprise at least one of glass fibers and carbon fibers.

11. A hinge system, comprising:
a first fiber tube formed from a multi-layer fiber substrate having a first set of fibers and a second set of fibers arranged therein;
a first assembly bracket having a first end and a second end, the first end of the first assembly bracket is movably coupled to the first fiber tube; and
a second assembly bracket having a first end and a second end, the first end of the second assembly bracket is movably coupled to the first fiber tube.

12. The hinge system of claim 11, wherein the respective first ends are curved and the respective second ends are substantially flat of the first assembly bracket and the second assembly bracket.

13. The hinge system of claim 11, wherein the first end of the first assembly bracket includes a first lubricated surface to contact the first fiber tube and the first end of the second assembly bracket includes a second lubricated surface to contact the first fiber tube.

14. The hinge system of claim 11, wherein the first fiber tube includes a first longitudinal opening to receive an electrical wire therein.

15. The hinge system of claim 11, wherein the first set of fibers and the second set of fibers comprise at least one of glass fibers and carbon fibers.
